(19) United States
(12) Patent Application Publication
(10) Pub. No.: US 2009/0173397 A1
(43) Pub. Date: Jul. 9, 2009

(54) Equipment Housing with Access Knockouts

(75) Inventors: Venkat R. Mallela, Tucson, AZ (US); David M. Redmond, Tucson, AZ (US)

Correspondence Address: FITCH EVEN TABIN AND FLANNERY, 120 SOUTH LASALLE STREET, SUITE 1600, CHICAGO, IL, 60603-3406, US

(73) Assignee: Rain Bird Corporation, Azusa, CA (US)

(21) Appl. No.: 11/969,305

(22) Filed: Jan. 4, 2008

(51) Int. Cl. F16L 5/00

(52) U.S. Cl. 137/364

(57) ABSTRACT

A housing to cover equipment disposed underground has a main body with at least one wall forming an interior space, at least one flange extending at least outwardly from the main body, and at least one knockout. The knockout has a wall section forming part of the wall of the main body and that is selectively detachable from the wall for providing an opening into the interior space. At least one flange section extends from the wall section at the flange and is selectively detachable from the flange.

### FIELD OF THE INVENTION

The invention relates to housings used to protect, and provide access to, underground system devices, and more particularly, to a housing that provides openings formed on the housing by the removal of knockouts for conduits to extend into the housing.

### BACKGROUND OF THE INVENTION

Valve boxes and other underground protective housings are used to protect pumps, valves, meters and other components of underground systems. These system components are typically connected to water pipes, wire conduits, and/or other types of conduits. The housings often have open bottoms so that they can be positioned over the underground component with the top of the housing being flush or slightly above or below the ground level. A lid covers the top of the housing thereby keeping out dirt and debris while permitting access to the system components for maintenance or replacement of the system component. The housings are typically made of plastic.

It is often desirable to have the system component placed on top of, or even spaced above, a sub-grade floor and within the valve box, rather than partially buried within the sub-grade floor, for convenient access to all sides of the system component. Since the sub-grade floor is often a dirt or gravel floor, it also is desirable to keep the system component as removed as possible from dirt, dust, or other harmful foreign matter or elements from the sub-grade floor that might reduce the useful life of the system component. Since many underground system components are attached along horizontal conduits of the underground system, the horizontal conduits also are typically disposed on top of, or spaced above, the sub-grade floor.

The bottom of the housing is usually placed flush on top of the sub-grade floor to prevent further dirt or other matter from entering the interior of the valve box. In this case, a conduit extending from the system component within the housing and above the sub-grade level will need clearance to extend through a sidewall of the valve box. Thus, for some plastic valve boxes, a conduit extends through an opening on the sidewall formed by removal of a knockout. Knockouts are thin or perforated sections of the valve box, or sections with a thin periphery connecting the knockout to the remainder of the valve box, so that the knockout is relatively easily removed from the sidewall of the housing by being punched out by hand or by a tool to cut the knockout away from the sidewall of the valve box.

Plastic valve boxes also typically have a continuous, thickened flange extending all the way around the bottom of the housing to provide a wide base for the housing to sit level upon. This is especially helpful on relatively uneven sub-grade floors made of gravel for example. The flange also increases rigidity and strength of the housing walls to better withstand both vertical and lateral forces from backfilled dirt placed against the valve box. Thus, the flange acts like a footing and helps to prevent tipping, bending or buckling of the housing sidewalls. When the sidewalls of the housing form a closed tubular shape, whether rectangular or circular, the continuous flange also helps to increase hoop strength, such that the flange alleviates direct lateral forces from backfill impacted on a first wall section by transferring some of those forces to other wall sections around the valve box. Finally, once backfill is placed on top of the flange, the flange acts as an anchor to prevent unintentional pull-out of the housing from the ground.

On conventional valve boxes, the knockouts are not continued onto the flange on the bottom of the housing because that would reduce the strength of the valve box. This is adequate when small diameter conduits extending from the system component are maintained at an elevation above the flange. Often times, however, this is not the case, and a section of the flange also must be cut out, in addition to the knockout on the sidewall, in order to provide clearance for the conduit to extend out of the valve box. Thus, on the known valve boxes, a cutting tool often is needed to cut the relatively thick flange to provide such clearance. Cutting the flange is typically strenuous and time consuming work depending on the tools available.

Once a conduit is placed through a hole created by the removal of a knockout, a gap often exists between the conduit and the opening in the box that allows dirt to fall into the interior of the housing when the area around the box is backfilled. Users have attempted to cover the gap with cardboard or duct tape before filling the dirt in around the valve box. However, this is often ineffective to adequately cover the gap.

On some known valve boxes, the knockout is a flat plate with a straight bottom edge that is removed from a sidewall of the valve box. In an attempt to cover at least some of the gaps on the opening, the removed knockout can be reattached to the housing to cover at least part of the opening. In this case, the flat bottom edge is placed on a typically cylindrical conduit extending through the opening so that significant gaps still exist between the straight edge and around the conduit that permit dirt to enter the interior of the valve box. Thus, there is a desire for a housing that addresses all of these shortcomings.

### BRIEF DESCRIPTION OF THE DRAWINGS

FIG. 1 is an upper perspective view of a housing separated from a cover and embodying aspects of the present invention;

FIG. 2 is a lower perspective view of the housing of FIG. 1 shown without the cover;

FIG. 3 is a side, cross-sectional view showing the housing of FIG. 1 placed underground for use;

FIG. 4 is another upper perspective view of the housing of FIG. 1 shown without its cover and with knockouts removed from the housing;

FIG. 5 is another upper, perspective view of the housing of FIG. 1 shown without its cover; and

FIG. 6 is an elevational view of the housing of FIG. 1 shown without its cover and showing a knockout reattached to the housing.

### DETAILED DESCRIPTION OF THE PREFERRED EMBODIMENTS

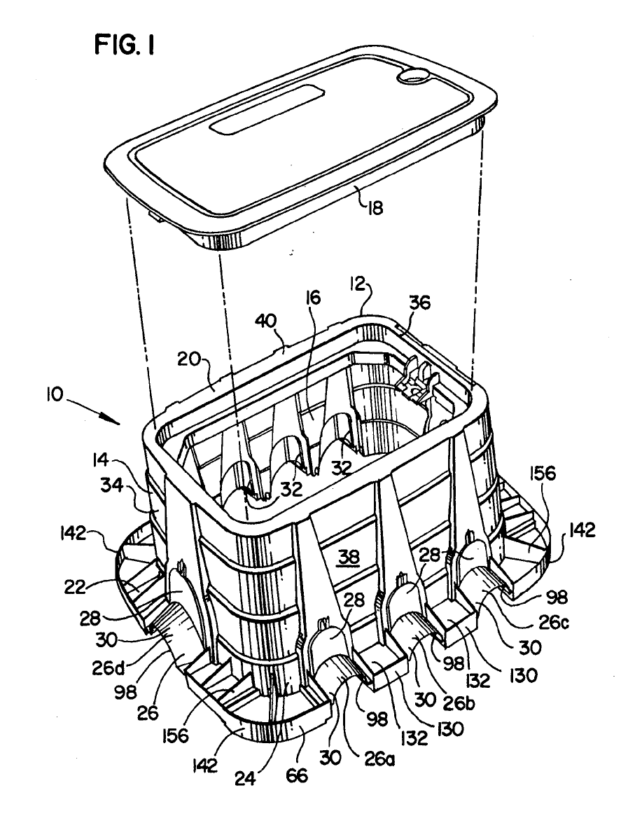

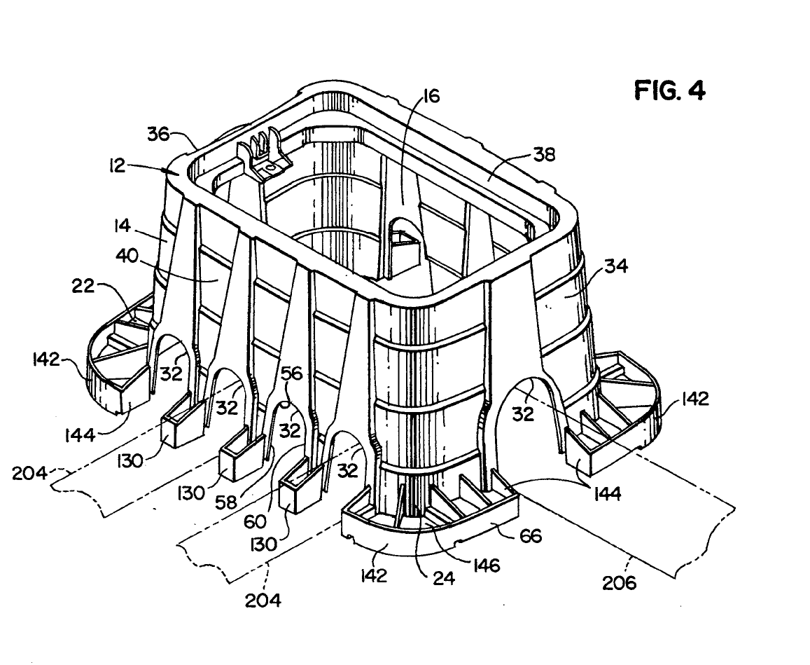

Referring to FIG. 1, a housing 10 has a main body 12 with at least one wall 14 forming an interior space 16. The main body 12 can be covered by a removable access cover 18 disposed on an upper rim 20 of the main body 12. At least one flange 22 extends outwardly from a lower portion 24 of the wall 14 and transverse to the wall 14. In order to provide clearance for conduits to extend through the wall 14, the housing 10 has one or more detachable knockouts 26. Each knockout 26 has a wall section 28 and a flange section 30. Removing a knockout 26 from wall 14 forms an opening 32 in the wall 14 and a break in the flange 22 (shown best on FIG. 4).

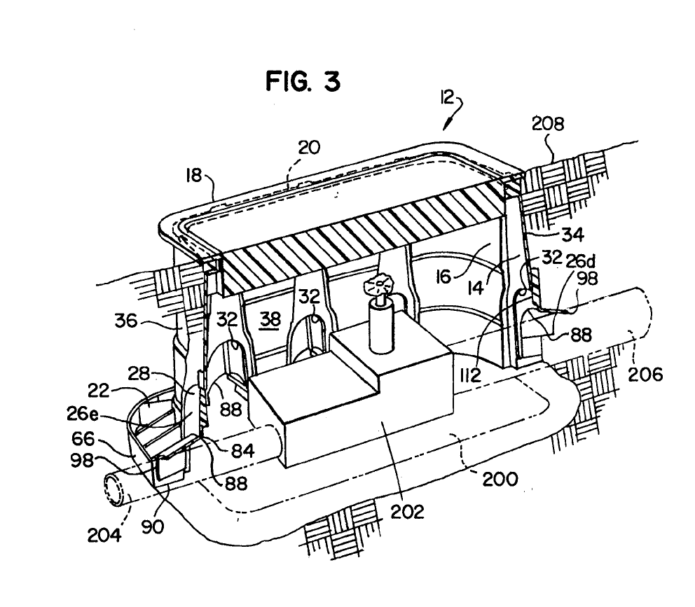

The flange 22 may be integrally formed with the wall 14 and provides a relatively wide base for the housing 10 for level and stable placement of the housing 10 on a sub-grade floor 200 (shown in FIG. 3). The flange 22 provides rigidity and strength to the housing 10 against both vertical and lateral external forces, such as forces from backfill placed against the housing 10 or equipment being driven over the top of the housing 10. The flange 22 reduces tipping, bending or buckling of the wall 14 by acting as a footing, and when extending continuously around the housing 10, by increasing the hoop strength of the housing. The flange 22 also may anchor the housing 10 in the ground once the backfill is placed over the flange 22.

The housing 10, in the illustrated form, is generally a rectangular cylinder or rectangular frustum with two opposite short sides 34 and 36 and two opposite long sides 38 and 40. Optionally, the main body 12 may be generally annular or other closed arcuate shape where a single wall extends continuously around the entire valve box. Even further, the main body 12 may be polygonal with three or more distinct sides where the sides may or may not be the same size, or may include any other combination of curved and/or flat sides with an open top and an open bottom.

As shown in FIG. 3, the housing 10 may be placed in a hole in the ground, dug out excavation, or a ditch, and rests on the sub-grade floor 200 over an underground system component 202. Such system components may include one or more valves and controllers for underground water supply or drainage systems. Alternatively or additionally, the system component 200 may include controllers, junction boxes, power supplies, and the like for electrical or communication systems, and/or any other device(s) that may fit within the housing 10 and is desirable to have placed underground while still being accessible for maintenance. In the illustrated example, the system component 202 is a valve connected to a small diameter conduit 204 and a relatively large conduit 206 that extends through the wall 14 of the housing 10. Herein, the term conduit refers to any elongate pipe or tubing that conveys fluids or small solids, or holds anything else, such as wires or cables. The system component 202 and conduits 204 and 206 are placed on or over the sub-grade floor 200 containing dirt, gravel, or other material that may be selected for its drainage properties. The flange 22 sits level on the sub-grade floor 200 which is located a distance below grade or ground level 208 to match the height of the housing 10. This places the cover 18 at or near grade level 208 so the cover 18 can be removed for access to the interior space 16 and the system component 202. The cover 18 may be secured to the upper rim 20 of the main body 12 by screws, snap-fit, key locks, or any other efficient securing mechanism that permits the cover to 18 to be lifted off of the housing 10 when desired.

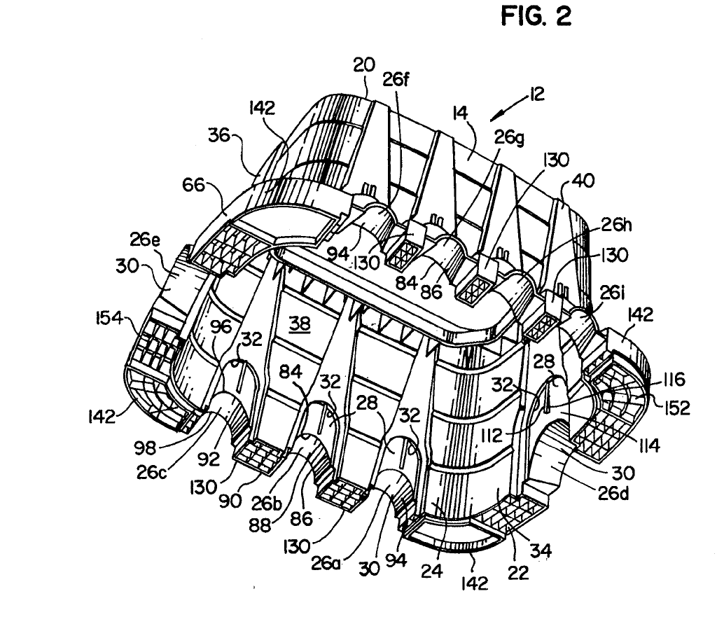

Referring to FIGS. 1-2, in order to provide clearance for conduits 204 and 206 to extend through wall 14, rather than requiring that the conduits 204 and 206 include an elbow to pass underneath and around wall 14, the housing 10 has at least one of the knockouts 26. The knockouts 26 may or may not be placed uniformly around the housing 10. In the illustrated example, the housing 10 has knockouts 26a to 26i generally referred to herein as knockouts 26, all with a similar basic structure but with differences explained in more detail below. The knockouts 26a to 26c are spaced uniformly along long side 38, knockouts 26d and 26e are centrally located on opposite short sides 34 and 36, respectively, and knockouts 26f to 26i are uniformly spaced along long side 40.

While in the present case, the knockouts 26 are shown to be placed on all sides of the housing 10 for versatility, and a number of knockouts are provided with different sizes to accommodate conduits of different sizes, this need not always be a combination, and at least one side of the housing 10 may have at least one knockout. It will be understood that the number and placement of the knockouts may be different depending on what is desired for a given system component to be covered and the conduits that attach to it. Features common to all of the knockouts are numbered similarly and may only be indicated on one of the knockouts 26.

Each illustrated knockout 26 has the wall section 28 forming part of the wall 14 of the main body 12, and the flange section 30 extending outward at the flange 22 and generally transverse from the wall section 28. The wall section 28 is detachable from the wall 14, while the flange section 30 is detachable from the flange 22. Once detached, a conduit 206 can extend through the resulting opening 32 and into the interior space 16, as shown on FIG. 3. In the illustrated example, the openings 32 are sized to accommodate up to approximately 3.5 inch diameter pipes but may be sized to accommodate conduits of other sizes or shapes.

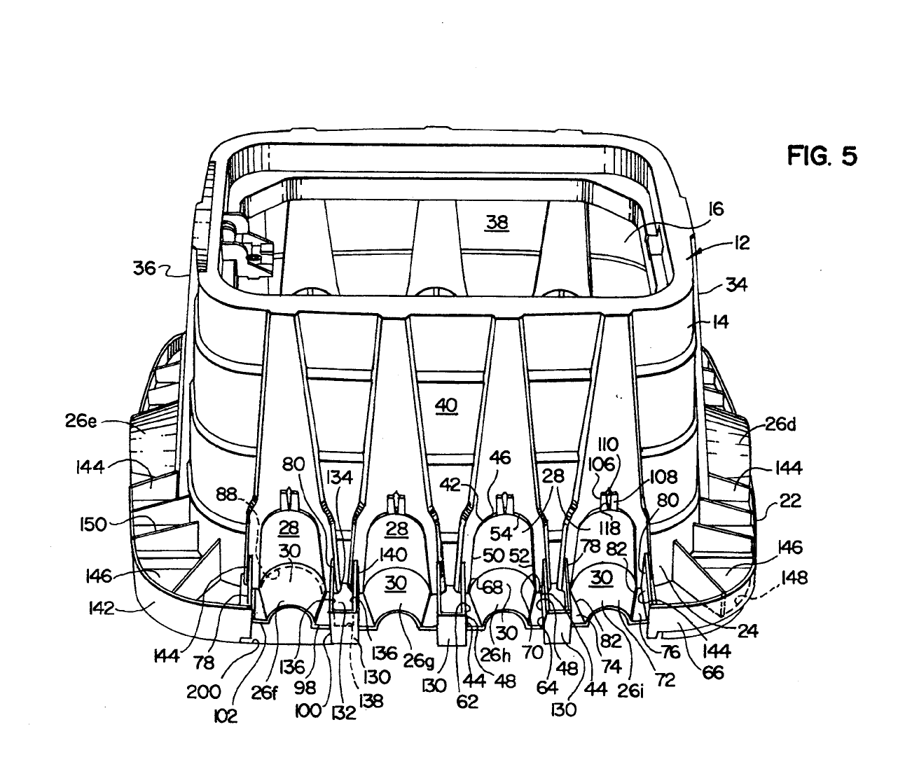

Referring to FIG. 5, in one form, the plastic housing 10 is molded or pressed from a plastic material with the knockouts 26 integrally formed with the wall 14 and the flange 22. In this case, integrally formed, thinned sections 42 and 44 respectively connect the wall section 28 and the flange section 30 to the wall 14 and the flange 22. The thinned sections 42 and 44 are sufficiently thin to tear without the use of a cutting tool. The knockout 26 may tear off of the housing 10 by hitting the knockout 26 by hand or with a heavy tool, such as a shovel or hammer, or by gripping the knockout by hand or a gripping tool and lifting the knockout 26 away from the remainder of the flange 22 and then the wall 14. In one form, the knockout 26 is one piece and the flange section 30 remains with the wall section 28 when the knockout 26 is detached from the housing 10 for reasons explained further below. It will be understood, however, that the flange section 30 also may be detachable from the wall section 28 by a thinned section between them similar to the thinned sections 42 and 44 if so desired.

The thinned sections 42 and 44 should be sufficiently thick to limit unintentional detachment of the knockouts 26 from the housing 10 due to external forces common when in use, such as backfill being placed against the housing 10 and, once the backfill is set, forces due to lateral earth pressure or hydraulic pressure from groundwater. Also, the knockouts 26 and the thinned sections 42 and 44 should be sufficiently thick so that when the knockout 26 remains integrally attached to the housing 10, the flange section 30 assists to make flange 22 continuous around the main body 12 such that the forces described above and impacted by the wall 14 and/or flange 22 are transferred throughout the flange 22 to absorb and dissipate the forces. In the illustrated form, the thinned sections 42 and 44 are approximately 0.02 to 0.04 inches thick while the knockouts 26 and the surrounding wall 14 and flange 22 are generally about 0.10 inches thick or greater.

The thinned sections 42 and 44 are located at the peripheries 46 and 48 of the wall section 28 and the flange section 30, respectively. To strengthen the housing 10 and limit unintentional detachment of the knockouts 26 from the housing 10, the length of the thinned sections 42 and 44 are maximized. Thus, in one example, the thinned sections 42 and 44 extend substantially continuously along peripheries 46 and 48. In other words, the wall section 28 is connected to the wall 14 by the thinned section 42 wherever the periphery 46 of the wall section 28 faces or opposes the wall 14. Likewise, the flange section 30 is connected to the flange 22 wherever the periphery 48 of the flange section 30 faces or opposes the flange 22. Thus, the thinned section 42, and in turn the periphery 46, extends along an inverted, generally U-shape with two generally parallel left and right segments 50 and 52 connected by an inverted semi-circular segment 54 (although other shapes are possible).

With this configuration, once the knockout 26 is removed, the opening 32 has a corresponding shape (as shown on FIG. 4) formed on the wall 14 with an inverted semi-circular edge 56 that may be sized to generally correspond to the outer diameter of a conduit placed within the opening 32. Two opposite edges 58 and 60 (also shown in FIG. 4) defining opening 32 may be parallel or may be tapered inward as they extend upward to correspond to the reduction in lateral wall space due to the tapering inward of the wall 14.

Similarly, the thinned section 44, and in turn the periphery 48, of the flange section 30 has two generally outwardly extending, opposite left and right segments 62 and 64 that are generally parallel to each other and that extend outwardly from the wall 14 to a distal rim 66 of the flange 22. The thinned section 44 also includes jog segments 68 and 70 extending along wall 14 and respectively interconnecting the thinned flange segments 62 and 64 to the thinned wall segments 50 and 52 of the thinned section 42.

In one form, the flange section 30 has a contoured portion 72 shaped to receive a conduit 204 or 206, and two flat left and right flange or wing portions 74 and 76 extending transversely from opposite sides of the contoured portion 72. The periphery 48 of the flange section 30, and in turn the thinned section 44, is formed on the wing portions 74 and 76 for connecting the flange section 30 to adjacent portions 78 and 80 of the flange 22. Alternatively, the separable thinned section 44 could be provided along seams 82 that transition the contoured portion 72 to the wing portions 74 and 76. It also will be understood that the wing portions 74 and 76 could be eliminated and the contoured portion 72 could directly attach to the adjacent portions 78 and 80 of the flange 22. It will be appreciated that, alternatively, the thinned sections 42 and 44 may extend on less than the full length of the peripheries 46 and 48 such as spaced at uniform or non-uniform locations on the peripheries 46 and 48.

Referring to FIG. 2, each knockout 26 also is configured to provide clearance for conduits with relatively smaller diameters without the need for removal of the knockout 26. Thus, the wall section 28 has a lower edge or surface 84 with a concave transverse profile 86 (i.e., from left to right side of the knockout while facing the knockout) that defines a groove 88 at the wall section 28 and between the lower surface 84 and the sub-grade floor 200, as shown in FIG. 3. The lower surface 84 extends sufficiently above a bottom surface 90 of the flange 22 that sits upon the sub-grade floor 200 to permit a small diameter conduit, such as conduit 204 as shown on FIG. 3, to extend through groove 88. The profile 86 may be arcuate including semi-circular or other forms to generally match the shape of the conduit 204.

The flange section 30 has a transverse profile 92 that aligns with the profile 86 of the lower surface 84 and conforms to the shape of the conduit 204 to provide clearance for the conduit 204 through the flange 22, or more specifically, under the flange section 30. In more detail, a lower surface 94 of the flange section 30 forms transverse profile 92 and extends flush from the lower surface 84 of the wall section 28. In one example, the profiles 84 and 92 are contoured to receive pipes or conduits with outer diameters of about 1 to 2 inches. The profiles of different knockouts may be dimensioned to align with, and provide clearance for, conduits of different sizes while the knockout 26 is still integrally attached to the housing 10. Optionally, some of the knockouts 26 may not provide such clearance.

In one form, the flange section 30 is semi-cylindrical or barrel vault shaped such that the lower surface 94 of the flange section 30 has a constant radius generally from a proximal end portion 96 of the flange section 30 and near the wall section 28 to a distal end portion 98 of the flange section 30 as shown for the knockouts 26a to 26c on the long side 38 of the main body 12. Alternatively, the flange section 30 may taper in as it extends away from the wall 14 so that the distal end portion 98 may be just slightly larger than a conduit of a certain size while maintaining a uniform width of the wall section 28 on the wall 14 from knockout to knockout. As shown on FIG. 3 with knockout 26e, the distal end portion 98 is only slightly larger than the conduit 204 to permit a slight amount of lateral play or adjustment of the conduit underneath the distal end portion 98 while still significantly impeding foreign particles from entering between the flange section 30 and the conduit. 204.

In the illustrated examples, the flange sections 30 of knockouts 26d to 26h taper inward as they extend outward from the wall 14 so that the distal end portion 98 of each flange section 30 has a profile with a smaller diameter than the diameter of the profile at the proximal end portion 96 at the wall section 28. This tapered configuration also provides clearance for flanged parts of a conduit with a larger outer diameter than the adjacent conduit, such as at the junction of two pipe pieces. The flanged part may be placed under the wall section by the larger diameter profile while a smaller diameter section of conduit may be placed at the distal end portion 98 of the flange section 30.

It will be appreciated that the flange section 30 may have many other shapes to accommodate conduits of unusual shapes, such as three dimensional shapes including a gable roof. The flange section 30 may have a transverse profile 92 on lower surface 94 that is linear, chevron, stepped, sloped, or grooved or any other shape to conform to the outer profile of a conduit received by the flange section 30. It will also be appreciated that the longer the flange section 30, the greater the amount of foreign particles the flange section 30 can impede. Thus, the flange section 30 may even be set to extend beyond the distal rim 66 to impede more foreign particles from entering beneath it as explained herein.

Referring to FIG. 5, a knockout 26 attached to the wall 14 and the flange 22, and while unused (i.e., no conduit is placed underneath the knockout 26), still assists to impede foreign particles from entering the interior space 16 through groove 88 formed by the wall section 28. More specifically, the flange section 30 cooperatively forms a cavity 100 under the flange section 30 and with left and right adjacent portions 78 and 80 of the flange 22 forming the sides of the cavity 100. With the sub-grade floor 200 forming the bottom of the cavity 100, the cavity 100 is generally enclosed except for the groove 88 on one end and an inlet end 102 formed at the distal end portion 98 of the flange section 30. So configured, when backfill is driven horizontally against the valve box, foreign particles must first enter the inlet end 102 and traverse the cavity 100 in order to enter the interior space 16 through groove 88. Thus, with the inlet end 102 spaced outwardly from the wall 14, foreign particles will not have sufficient momentum to traverse the length of cavity 100 necessary to enter interior space 16.

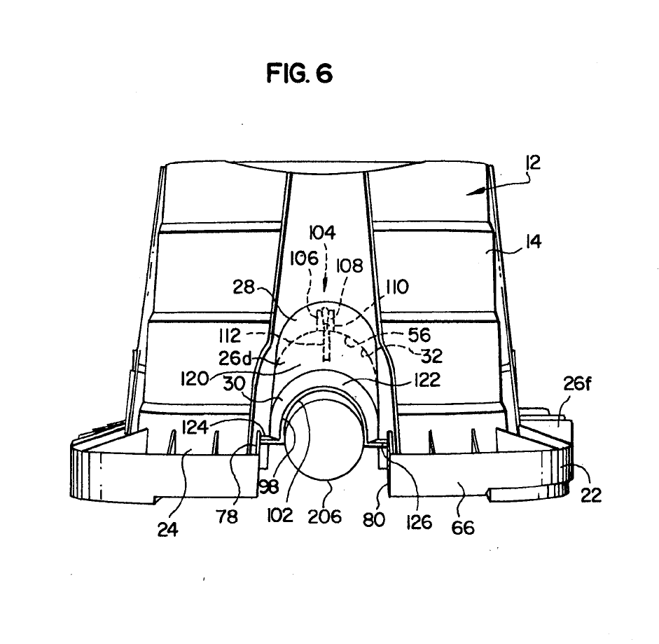

Referring to FIG. 6, once the knockout 26 is detached from the housing 10, it may be reattached to the wall 14 by a releasable connection 104 so that the knockout 26 covers at least part of the opening 32 to further impede foreign particles from entering the interior space 16. Specifically, at least one, but here two spaced blocks 106 and 108 protrude from wall 14 just above each opening 32 and define an elongate groove 110 that forms a circular bore (also shown in FIG. 5). While the groove generally extends in a vertical direction, it will be understood that the groove 110 could extend in other directions. The groove 110 receives an elongate pin 112 held on a back side 114 of each knockout 26 by a spacer 116 (FIG. 2). The blocks 106 and 108 form an elongate gap 118 (FIG. 5) that extends along the groove 110 to provide clearance for the spacer 116 to extend out of the groove 110 when the pin 112 is disposed within the groove 110. The blocks 106 and 108, however, form a sufficient amount of the circumference of the groove 110 so that pin 112, which has a diameter greater than the width of the spacer 116, cannot be pulled laterally out of the groove 110 through the gap 118.

Referring to FIGS. 3 and 6, the knockout 26 may be reattached to the wall 14 and above conduit 206 by sliding the pin 112 into the groove 110 until the distal end portion 98 of the flange section 30 engages the conduit 206. While the pin and groove connection permits the flange section 30 to be located at the same height as the upper edge 56, as shown in FIG. 6, the opening 32 is taller than it is wide so that in the typical situation where a circular conduit or pipe 206 extends through the opening 32, the wall section 28 of the knockout 26 covers an upper part 120 of the opening 32. If the contoured portion 72 of the flange section 30 is tapered, like that shown for knockouts 26d (as well as 26a to 26c and 26e), the flange section 30 covers the next lower part 122 of opening 32 adjacent the upper part 120.

Whether tapered or not, the adjacent portions 78 and 80 on the flange 22 that face opposite sides 124 and 126 of the flange section 30 have sufficient height so that even when the knockout 26 is reattached to the housing 10 and placed over a conduit 206 depending on the size of the conduit, the flange section 30 still extends directly between the adjacent portions 78 and 80 to generally enclose the cavity 100 underneath the flange section 30 and between the adjacent portions 78 and 80. This generally impedes foreign particles from entering the cavity 100 along the left and right sides 124 and 126 of the flange section 30.

Referring to FIGS. 4-5, to strengthen the flange 22 when one or more knockouts 26 are absent from the housing 10, the flange 22 has at least one rib 130, but in the illustrated form has a plurality of ribs 130, where each rib extends outward from the main body 14 and between two adjacent knockouts 26. Each rib 130 has a generally horizontal, planar or flat interior portion 132 extending from the wall 14. In the illustrated form, the interior portion 132 extends perpendicular to the wall 14 but may extend at other desired angles. The interior portion 132 has an outer edge portion 134 extending away from the wall section and forming opposite sides 136 of the interior portion 132 as well as a distal side 138 relative to the wall 14. The rib 130 also has a generally U-shaped sidewall 140 that substantially extends along the entire outer edge portion 134 including the sides 136 and 138. The sidewall 140 extends both upward and downward from the flat interior portion 132 and transversely from both the interior portion 132 and the wall 14 along the sides 136 of the interior portion 132. The sidewall 140 at the distal side 138 provides for a thickened or widened distal rim 66.

Similarly, corner portions 142 of the flange 22 have transverse sidewalls 144 similar in shape to the sidewall 140 of the ribs 130 and that extend both upward and downward from a flat, horizontally extending, interior portion 146. The sidewalls 144 also extend along an exterior edge portion 148 of the corner portions 142 to form the corners of the distal rim 66. An upper edge 150 of the sidewalls 140 and 144 slants upward as the sidewalls extend toward the wall 14. Sidewalls 140 and 144 form the adjacent portions 78 and 80 that are connected to the wing portions 74 and 76 on the left and right sides 124 and 126 of the flange section 30 by the thinned section 44. Thus, the flange sections 30 are disposed either between two ribs 130 (at knockouts 26b, 26g, and 26h), between a rib 130 and a corner portion 142 (at knockouts 26a, 26c, 26f, and 26i), or between two corner portions 142 (at knockouts 26d and 26e).

The interior portions 132 and 146 also are set at the same height on the flange 22 as the wing portions 74 and 76 of the flange sections 30 so that the interior portions 132 and 146 and wing portions 74 and 76 of a flange section 30 remaining attached to the flange 22 generally form a continuous horizontal plate for the flange 22 (albeit bent at contoured portions 72 of the flange sections 30) for transferring, absorbing, and/or dissipating forces.

Referring to FIG. 2, to further strengthen the flange 22, an underside 152 of the ribs 130 and the corner portions 142 may be made of an array of circumferentially and transversely extending bracing plates 154, that in one form, form a waffle pattern to strengthen the flange 22. The bracing plates 154 extend downward from the interior portions 132 on each rib 130 as well as from the interior portion 146 of the corner portions 142. Additional braces 156 (FIG. 1) may also extend on the flange 22 and above the interior portions 132 and 146, and outwardly from the wall 14 to the distal rim 66.

Referring again to FIG. 1, due to the added rigidity and strength provided by the ribs 140 and corner portions 142, a thickened flange portion does not need to extend in front of the flange sections 30 to maintain the strength of the flange 22. Thus, the flange sections 30 generally extend toward the distal rim 66, and the distal end portion 98 of the flange sections 30 form a portion of the distal rim 66 that may be detached from the rest of the distal rim 66 without the use of a cutting tool.

While the invention has been described with respect to specific examples including presently preferred modes of carrying out the invention, those skilled in the art will appreciate that there are numerous variations and permutations of the above described systems and techniques that fall within the scope of the invention as set forth in the appended claims.

What is claimed is:

1. A housing to cover equipment disposed underground, the housing comprising:
a main body having at least one wall forming an interior space;
at least one flange extending at least outwardly from the main body;
at least one knockout comprising:
a wall section forming part of the at least one wall and being selectively detachable from the at least one wall for providing an opening into the interior space, and
at least one flange section extending from the wall section at the at least one flange and being selectively detachable from the at least one flange.

2. The housing of claim 1 wherein the at least one flange has a distal rim spaced from the main body, and the at least one flange section generally extends toward the distal rim and forms a detachable portion of the distal rim.

3. The housing of claim 1 further wherein the flange comprises at least one rib extending from the main body and adjacent the at least one flange section, the flange section being detachable from the at least one rib.

4. The housing of claim 3 wherein the at least one flange has a distal rim spaced from the main body, and wherein the at least one rib has a distal portion forming part of the distal rim.

5. The housing of claim 3 wherein the at least one rib comprises a planar interior portion extending from the wall section, and a peripheral sidewall extending from the interior portion and transversely to both the interior portion and the wall section.

6. The housing of claim 5 wherein the interior portion of the at least one rib comprises an outer edge portion extending away from the wall section, the outer edge portion forming opposite sides of the interior portion, and wherein the sidewall substantially extends along the entire edge portion.

7. The housing of claim 5 wherein the sidewall is generally U-shaped.

8. The housing of claim 3 further comprising multiple flange sections of multiple knockouts, and wherein the at least one rib is disposed between at least two adjacent flange sections.

9. The housing of claim 3 wherein the at least one flange section of the at least one knockout is disposed between two of the at least one ribs, and wherein each of the two ribs has a sidewall on an opposite side of the at least one flange section for receiving a conduit underneath the at least one flange section and between the sidewalls.

10. The housing of claim 1 wherein the at least one flange section remains with the wall section when the at least one knockout is detached from the valve box.

11. The housing of claim 1 wherein the at least one flange comprises a remainder other than the at least one flange section, and a thinned section connecting the at least one flange section to the remainder of the at least one flange and capable of being torn to detach the at least one flange section from the at least one flange.

12. The housing of claim 1 wherein the at least one flange section is integrally formed with the at least one flange.

13. The housing of claim 1 wherein the at least one flange section is detachable from the wall section of the at least one knockout.

14. The housing of claim 1 wherein the at least one flange section forms a portion of the at least one flange to form a continuous flange.

15. The housing of claim 1 wherein the at least one flange section extends outwardly from the wall section of the least one knockout for covering at least a portion of the opening to restrict foreign particles from entering the interior space.

16. The housing of claim 1 wherein the at least one flange section forms a cavity shaped to receive a conduit.

17. The housing of claim 1 wherein the at least one flange section defines at least in part a cavity and an inlet end to the cavity that is spaced from the at least one wall to impede entry of foreign particles through the opening and into the interior space.

18. The housing of claim 1 wherein the at least one knockout is configured to be reattached to the wall and adjustably positioned at the opening so that the at least one flange section is positioned to alternatively receive conduits of different sizes and to at least partially shield the opening from foreign particles.

19. The housing of claim 1 comprising a plurality of the knockouts, and wherein the at least one flange section on one knockout of the plurality of knockouts is a different size from the at least one flange section on another knockout of the plurality of knockouts.

20. The housing of claim 1 wherein the at least one flange section tapers as it extends outwardly and generally transverse to the wall section.

21. The housing of claim 1 wherein the at least one flange section generally forms at least one shape selected from the group comprising:
a three dimensional shape being one of: barrel vault, gable roof,
a transverse profile being one of: linear, chevron, stepped, sloped, grooved, curved, concave.

22. The housing of claim 1 wherein the wall section of the at least one knockout has a lower surface having a concave profile for receiving a conduit.

23. The housing of claim 22 wherein the at least one flange section has a profile, and wherein the lower surface has a profile matching the profile of the at least one flange section.

24. A housing to cover equipment disposed underground, the housing comprising:
a main body forming an interior space;
a plurality of knockouts selectively detachable from the main body for providing an opening into the interior space and having a wall section and at least one flange section extending outwardly from, and generally transverse to, the wall section; and
a flange having a plurality of ribs extending outward from the main body, wherein each rib is disposed between adjacent knockouts and is detachably connected to at least one of the at least one flange sections.

25. A housing to cover equipment disposed underground, the housing comprising:
a main body forming an interior space;
at least one knockout selectively detachable from the main body and having at least one flange section extending outwardly from the main body and being arcuate to conform to an outer profile of a conduit.
